(19) United States
(12) Patent Application Publication
(10) Pub. No.: US 2024/0338420 A1
(43) Pub. Date: Oct. 10, 2024

(54) APPARATUS AND METHOD FOR PROCESSING DATA FOR EXTERNAL USERS

(71) Applicant: Gravystack, Inc., Phoenix, AZ (US)

(72) Inventors: Chad Willardson, Phoenix, AZ (US); Scott Donnell, Phoenix, AZ (US); Travis Adams, Phoenix, AZ (US)

(73) Assignee: Gravystack, Inc., Phoenix, AZ (US)

(21) Appl. No.: 18/131,698

(22) Filed: Apr. 6, 2023

(51) Int. Cl. G09B 19/00; G06F 18/24

(52) U.S. Cl. CPC G06F 18/24765; G06Q 50/01

(57) ABSTRACT

An apparatus and method for processing data for external users is disclosed. The apparatus includes at least a processor and a memory containing instructions communicatively connected to the at least a processor. The at least a processor is configured to obtain system data, wherein the system data includes system user data, one or more system behavioral groups, a system behavioral pattern and a system action advisory assignment, receive external user data, classify the external user data into one or more external behavioral groups, determine an external behavioral pattern of the external user data in the one or more external behavioral groups as a function of the system data, and generate an external action advisory assignment for an external user as a function of the system data.

### FIELD OF THE INVENTION

The present invention generally relates to the field of data analysis. In particular, the present invention is directed to an apparatus and method of processing data for external users.

### BACKGROUND

Recognizing the consequences of a behavior could be difficult; however, it is often beneficial to recognize the consequences of behavior. Providing proper guidelines or aid may be beneficial as well. Some behavior patterns may be difficult for automated processes to detect, quantify, and generate as the data that represents them can be nebulous. Existing solutions to these problems are not sufficient and can be improved.

### SUMMARY OF THE DISCLOSURE

In an aspect, an apparatus for processing data for external users is disclosed. The apparatus includes at least a processor and a memory containing instructions communicatively connected to the at least a processor. The at least a processor is configured to obtain system data, wherein the system data includes system user data, one or more system behavioral groups, a system behavioral pattern and a system action advisory assignment, receive external user data, classify the external user data into one or more external behavioral groups, determine an external behavioral pattern of the external user data in the one or more external behavioral groups as a function of the system data, and generate an external action advisory assignment for an external user as a function of the system data.

In another aspect, a method for processing data for external users is disclosed. The method includes obtaining, using at least a processor, system data, wherein the system data includes system user data, one or more system behavioral groups, a system behavioral pattern and a system action advisory assignment, receiving, using the at least a processor, external user data, classifying, using the at least a processor, the external user data into one or more external behavioral groups, determining, using the at least a processor, an external behavioral pattern of the external user data in the one or more external behavioral groups as a function of the system data, and generating, using the at least a processor, an external action advisory assignment for an external user as a function of the system data.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is an exemplary embodiment of an apparatus for processing data for external users;

FIG. 2 is a block diagram of an exemplary embodiment of a pattern database;

FIG. 3 is a block diagram of an exemplary machine-learning process;

FIG. 4 is a diagram of an exemplary embodiment of neural network;

FIG. 5 is a diagram of an exemplary embodiment of a node of a neural network;

FIG. 6 is a graph illustrating an exemplary relationship between fuzzy sets;

FIG. 7 is a flow diagram illustrating an exemplary method for processing data for external users; and

FIG. 8 is a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

At a high level, aspects of the present disclosure are directed to an apparatus and method for processing data for external users. The apparatus includes at least a processor and a memory containing instructions communicatively connected to the at least a processor. The at least a processor is configured to obtain system data, wherein the system data includes system user data, receive external user data, classify the external user data into one or more external behavioral groups, determine an external behavioral pattern of the external user data in the one or more external behavioral groups as a function of the system data, and generate an external action advisory assignment for an external user as a function of the system data.

Aspects of the present disclosure can be used to improve a user's financial literacy. In some embodiments, the present disclosure can improve a user's ability to understand and effectively use one's financial skill, wherein the financial skill may include financial management, budgeting, investing, and the like. Aspects of the present disclosure can also be used to increase a user's interest in financing. Exemplary embodiments illustrating aspects of the present disclosure are described below in the context of several specific examples.

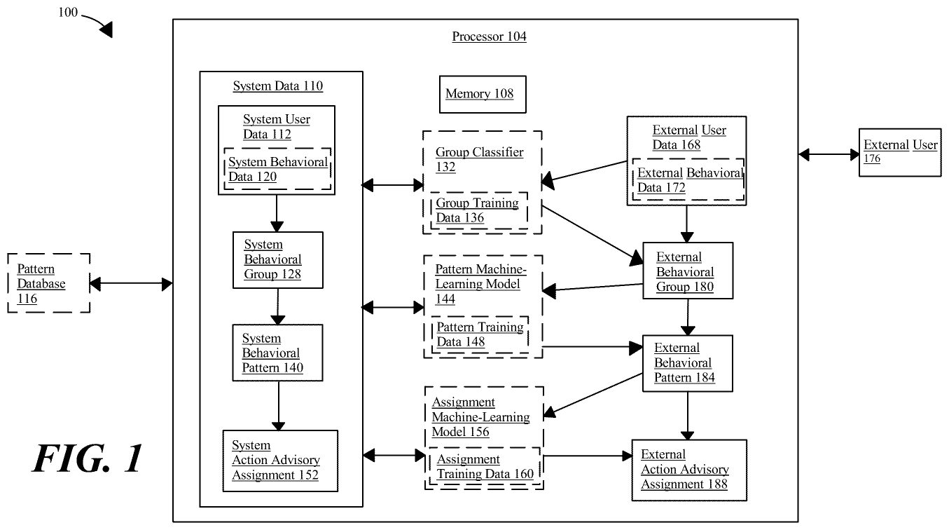

Referring now to FIG. 1, an exemplary embodiment of an apparatus 100 for processing data for external users is illustrated. Apparatus 100 includes at least a processor 104. The at least a processor 104 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. The at least a processor 104 may include a single computing device operating independently, or may include two or more computing device operating in concert, in parallel, sequentially or the like; two or more computing devices may be included together in a single computing device or in two or more computing devices. The at least a processor 104 may interface or communicate with one or more additional devices as described below in further detail via a network interface device. Network interface device may be utilized for connecting the at least a processor 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. The at least a processor 104 may include but is not limited to, for example, a computing device or cluster of computing devices in a first location and a second computing device or cluster of computing devices in a second location. The at least a processor 104 may include one or more computing devices dedicated to data storage, security, distribution of traffic for load balancing, and the like. The at least a processor 104 may distribute one or more computing tasks as described below across a plurality of computing devices of computing device, which may operate in parallel, in series, redundantly, or in any other manner used for distribution of tasks or memory between computing devices. The at least a processor 104 may be implemented using a “shared nothing” architecture in which data is cached at the worker, in an embodiment, this may enable scalability of apparatus 100 and/or computing device.

With continued reference to FIG. 1, the at least a processor 104 may be designed and/or configured to perform any method, method step, or sequence of method steps in any embodiment described in this disclosure, in any order and with any degree of repetition. For instance, the at least a processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. The at least a processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, an apparatus 100 includes a memory 108 communicatively connected to at least a processor 104. As used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, and without limitation, using a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, a memory 108 includes instructions configuring at least a processor 104 to obtain system data 110. For the purposes of this disclosure, “system data” is any data that is obtained previously and related to a system user. For the purposes of this disclosure, a “system user” is a user that has an account on a system managed by apparatus 100. an external user. For the purposes of this disclosure, a “user” is any individual, a group of persons, an entity using a system any time. As a non-limiting example, a system user may include a 6-years-old female, a 13-years-old male, 18-years-old male, 25-years-old female, a whole family, a high-school student, a group of students, a teacher, a financial advisor, an accounting company, a school, and/or the like. In some embodiments, system data 110 includes system user data 112, system behavioral group 128, system behavioral pattern 140 and system action advisory assignment 152. For the purposes of this disclosure, “system user data” is data related to a system user. In some embodiments, system user data 112 may be stored in a pattern database 116. In some embodiments, system user data 112 may be retrieved from a pattern database 116. The pattern database 116 disclosed herein is further described in detail below. Additionally without limitation, system user data 112 disclosed herein may be consistent with user data found in U.S. patent application Ser. No. 18/131,647, filed on Apr. 6, 2023, and titled “APPARATUS AND METHODS FOR DETECTING A PATTERN TO GENERATE AN ASSIGNMENT,” having attorney docket number 1325-026USU1, the entirety of which is incorporated by reference herein.

With continued reference to FIG. 1, in an embodiment, system user data 112 may include system personal data. For the purposes of this disclosure, “system personal data” is data related to a system user's personal information. As a non-limiting example, system personal data may include name, gender, social security number, personal schedules, hobbies, personality type, dependents, family, profession, a life goal, a career goal, and the like. In some embodiments, system personal data may be retrieved from pattern database 116. In another embodiment, system user data 112 may include system user financial data. For the purposes of this disclosure, “system user financial data” is data related to a system user's finance. As a non-limiting example, system user financial data may include cash reserves, assets, stocks, bonds, mutual funds, exchange-traded funds (ETF), equity, debts, real estates, incomes, financial goals, business plan, retirement accounts, liabilities, and the like. In some embodiments, system user financial data may be retrieved from pattern database 116.

With continued reference to FIG. 1, in some embodiments, system user data 112 may include system behavioral data 120 of a system user. For the purposes of this disclosure, “system behavioral data” is data relating to a system user's habits or tendencies. As a non-limiting example, system behavioral data 120 may include system educational behavior, system vocational behavior, system pecuniary behavior, system social media behavior, and the like. For the purposes of this disclosure, an “system educational behavior” is a behavior of a system user that is related to an education. As a non-limiting example, a system educational behavior may include amount of time invested in for studying a mid-term exam, amount of money used to buy a textbook, amount of time invested in to create a mid-term exam, a list of courses a system user takes for a summer semester, and the like. In some embodiments, a system educational behavior may include a formal and informal education and training a system user has received. In an embodiment, an education may include a degree. As a non-limiting example, a degree may include Bachelors, Masters, High School Diploma, Ph.D., Middle School Diploma, Elementary school diploma, Kindergarten diploma, and the like. In another embodiment, an education may include an occupational certification. As a non-limiting example, Pipefitting certification, commercial driver's license, welding certification, and the like. In some embodiments, an education may include job training. In some embodiments, system educational behavior may be retrieved from pattern database 116.

For the purposes of this disclosure, a “system vocational behavior” is a behavior of a system user that is related to a vocation. As a non-limiting example, system vocational behavior may include amount of time invested in searching for a new job, amount of time invested to learn a new skill for a job, time spent to learn a new skill, working hour, a career goal, and the like. In some embodiments, system vocational behavior may be retrieved from pattern database 116.

With continued reference to FIG. 1, for the purposes of this disclosure, a “system social media behavior” is a behavior of a system user that is related to social media. As a non-limiting example, system social media behavior may include posting, browsing time, browsed contents, commenting, and the like. As used in this disclosure, a “social media” is a content sharing platform. As a non-limiting example, social media may include Google, Instagram, Facebook, LinkedIn, and the like. In some embodiments, system social media behavior may be retrieved from pattern database 116.

With continued reference to FIG. 1, for the purposes of this disclosure, a “system pecuniary behavior” is a behavior of a system user related to money. In an embodiment, system pecuniary behavior may include real-life system pecuniary behavior. As a non-limiting example, system pecuniary behavior may include earning money, spending money, saving money, donating money, bank activity, investing, and the like. As another non-limiting example, a system pecuniary behavior may include increase rate of salary, a time when a system user get a bonus, a time when a system user get an allowance, amount of money a system user get as an allowance, amount of money a system user withdraw from a saving account at once, amount of money a system user put money in a saving account, what a system user buy in a restaurant, shopping at a mall, donating money to a charity once a month, groceries shopping, online shopping, products bought online, amount of money spent for online shopping, websites used for online shopping, stock investing, buying a house, borrowing money from a parent, borrowing money from a bank, paying back to a parent, paying back to a credit union, paying credit card, spending with a credit card, spending with a debit card, public transportation fee, and the like. In another embodiment, system pecuniary behavior may include an online system pecuniary behavior. As a non-limiting example, online system pecuniary behavior may include purchasing a game item with in-game currency, exchanging money and in-game currency, wherein in-game currency is any type of money used within a game, and the like. In some embodiments, system pecuniary behavior may be retrieved from pattern database 116.

With continued reference to FIG. 1, at least a processor 104 may be configured to classify system user data 112 into one or more system behavioral groups 128. As used in this disclosure, a “behavioral group” is a set of associative system user data. As a non-limiting example, one or more system behavioral groups 128 may include system educational group, system vocational group, system social media group, system pecuniary group, system personal group, and the like. For the purposes of this disclosure, an “system educational group” is a set of associative system user data of a system educational behavior. As a non-limiting example, system educational group may include a school attendance group, course attendance group, course group, diploma group, study time group, subjects group, and the like. For the purposes of this disclosure, a “system vocational group” is a set of associative system user data of a system vocational behavior. For the purposes of this disclosure, a “system social media group” is a set of associative system user data of a system social media behavior. For the purposes of this disclosure, a “system pecuniary group” is a set of associative system user data of a system pecuniary behavior. In some embodiments, a system pecuniary group may include system spending group, system saving group, system investing group, system donating group, and the like. As a non-limiting example, system spending group may include system purchased product group, system groceries shopping group, system online shopping group, system paying debts group, system paying credit card payments group, system paying a rent group, credit card group, system debit card group, system online game group, and the like. As another non-limiting example, system investing group may include system stocks group, system bonds group, system trusts group, system real-estates group, and the like. As another non-limiting example, system saving group may include system withdraw group, system saving group, and the like. As another non-limiting example, system donating group may include system purchased products for donation group, system donating companies group, and the like. For the purposes of this disclosure, a “system personal group” is a set of associative system user data of a system personal behavior. As a non-limiting example, system personal group may include system missing due dates group, system personality test results group, system family group, system life goal group, system schedule group, and the like.

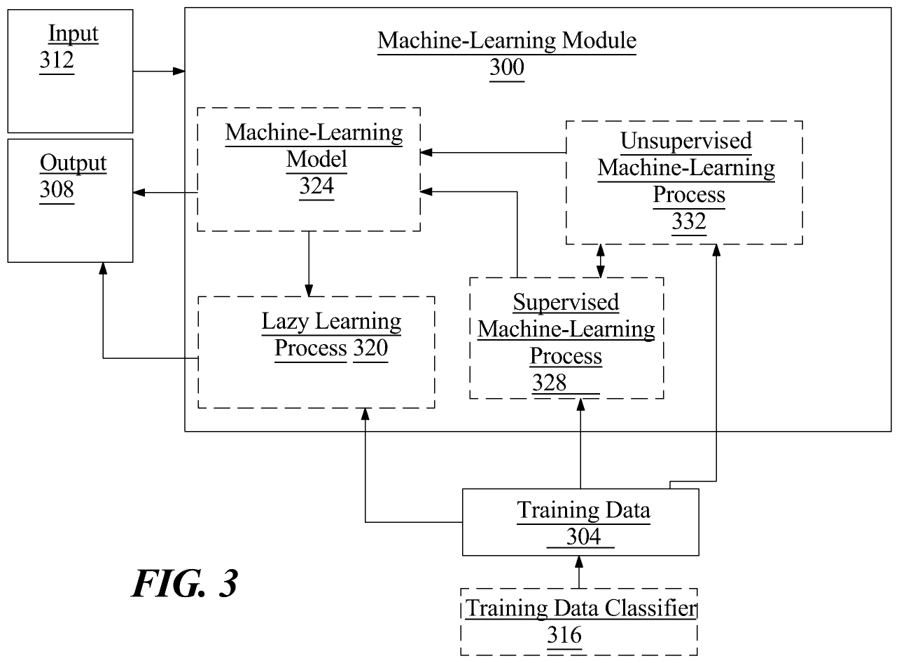

With continued reference to FIG. 1, in some embodiments, at least a processor 104 may be configured to classify system user data 112 into one or more system behavioral groups 128 using a group classifier 132. As used in this disclosure, a “group classifier” is a machine-learning model, such as a mathematical model, neural net, or program generated by a machine learning algorithm known as a “classification algorithm,” that sorts composition data related inputs into categories or bins of data, outputting a plurality of composition groups associated therewith. The group classifier 132 disclosed herein may be consistent with a classifier disclosed with respect to FIG. 3. In some embodiments, a group classifier 132 may be trained with group training data 136 correlating system user data 112 to one or more system behavioral groups 128. As a non-limiting example, a group classifier 132 may correlate amount of money donated to charity to system donation group. As another non-limiting example, a group classifier 132 may correlate a number of times a system user withdraws money from a saving account to system withdraw group of system saving group. In some embodiments, group training data 136 may be received from a system user, a third party, pattern database 116, external computing devices, previous iterations of processing, and/or the like. In some embodiments, inputs and outputs of a group classifier 132 may be used to train the group classifier 132. In some embodiments, group training data 136 may be stored in pattern database 116. In some embodiments, group training data 136 may be retrieved from pattern database 116.

With continued reference to FIG. 1, in some embodiments, system behavioral data 120 may be classified to one or more system behavioral groups 128 using a group lookup table. A “lookup table,” for the purposes of this disclosure, is an array of data that maps input values to output values. A lookup table may be used to replace a runtime computation with an array indexing operation. In some embodiments, at least a processor 104 may ‘lookup’ a given system user data 112 to one or more system behavioral groups 128. As a non-limiting example, at least a processor 104 may ‘lookup’ a given amount of money donated to charity to system donation group. As another non-limiting example, at least a processor 104 may ‘lookup’ a given a number of times a system user withdraw money from a saving account to system withdraw group of system saving group.

With continued reference to FIG. 1, at least a processor 104 is configured to determine a system behavioral pattern 140 of a system user as a function of one or more system behavioral group 128. For the purposes of this disclosure, a “system behavioral pattern” is data relating to a system user's reoccurring behaviors. In some embodiments, system behavioral pattern 140 may include a range of time. As a non-limiting example, a range of time may include an hour, a day, 3 days, a week, 2 weeks, 5 weeks, a month, 6 months, a year, 10 years, and the like. In an embodiment, system behavioral pattern 140 may include system educational behavior pattern, system vocational behavior pattern, system pecuniary behavior pattern, system social media behavior pattern, system personal behavior pattern, system sharing behavior pattern, and the like. In some embodiments, a system behavioral pattern 140 may be stored in pattern database 116. In some embodiments, a system behavioral pattern 140 may be retrieved from pattern database 116.

With continued reference to FIG. 1, for the purposes of this disclosure, an “system educational behavior pattern” is a system behavioral pattern of a system user related to education. As a non-limiting example, a system educational behavior pattern may include a list of scores a system user get in a certain subject at school in a semester, a frequency of a system user taking a certain subject at school in a semester, a number of times a system user missing a deadline for an assignment in a year, a frequency of taking an online course in a month, a number of times a system user achieved a career goal within 3 years, and the like. For the purposes of this disclosure, a “subject” is an area of knowledge that a system user can study. As a non-limiting example, a subject may include math, science, literature, music, and the like.

With continued reference to FIG. 1, for the purposes of this disclosure, a “system vocational behavior pattern” is a system behavioral pattern of a system user related to user's vocation. As a non-limiting example, a system vocational behavior pattern may include most frequently searched job titles, amount of time a system user spends to search for a new job for a week, amount of time a system user worked in the office for 5 days, amount of time a system user worked from home for a month, a frequency a system user worked from home for 3 months, and the like.

With continued reference to FIG. 1, for the purposes of this disclosure, a “system social media behavior pattern” is a system behavioral pattern of a system user related to social media. As a non-limiting example, a system social media behavior pattern may include browsing pattern, posting pattern, commenting pattern, and the like. As another non-limiting example, a system social media behavior pattern may include a frequency a system user opens social media in a day, a type of contents a system user sees in social media, types of contents a system user created amount of time a system user spends in social media, and the like. For the purposes of this disclosure, a “system personal behavior pattern” is a behavioral pattern related to a system user's personality. As a non-limiting example, a system personal behavior pattern may include a frequency a system user procrastinates paying a rent fee for 10 years, a frequency a system user has done house chores for 1 week, and the like.

With continued reference to FIG. 1, for the purposes of this disclosure, “system pecuniary behavior pattern” is a system behavioral pattern of a system user related to money. As a non-limiting example, system pecuniary behavior pattern may include spending habit, saving habit, investing habit, and the like. As another non-limiting example, system pecuniary behavior pattern may how many times a system user do online shopping in a month, a frequency of getting an allowance, average money a system user spend on online games each month for 6 months, a frequency of a system user withdrawing money from a saving account, amount of money a system user put into saving account in regular base, amount of money a system user spend on investment each month for a year, a frequency of a system user and the like.

With continued reference to FIG. 1, at least a processor 104 may determine system behavioral pattern 140 as a function of one or more system behavioral groups 128 using a pattern machine-learning model 144. For purposes of this disclosure, a “pattern machine-learning model” is a machine-learning model that generates a behavioral pattern. Pattern machine-learning model 144 disclosed herein may be consistent with a machine-learning model described with respect to FIG. 3. In some embodiments, pattern machine-learning model 144 may be trained with pattern training data 148 correlating one or more system behavioral group 124 to a system behavioral pattern 140. For purposes of this disclosure, “training data” is data containing correlations that a machine-learning process may use to model relationships between two or more categories of data elements. As a non-limiting example, a pattern machine-learning model 144 may receive pattern training data 148, wherein the pattern training data 148 may include system online game purchase group of a system pecuniary group and may determine system behavioral pattern 140 from the system online game purchase group such as without limitation a system pecuniary behavior pattern of average amount of money spent for online game each month for a year. As another non-limiting example, a pattern machine-learning model 144 may receive pattern training data 144, wherein the pattern training data 148 may include system online game purchase group of a system pecuniary group and the pattern machine-learning model 144 may determine a system pecuniary behavior pattern of a frequency of the system user spent in-game currency for online game each month for 6 months. As another non-limiting example, a pattern machine-learning model 144 may receive pattern training data 148, wherein the pattern training data 148 may include system school attendance group and determine a system behavioral pattern 140 of a system educational system behavioral pattern 140 of a frequency of missing a class for a month. In some embodiments, pattern training data 148 may be received from pattern database 116, external computing devices, and/or previous iterations of processing. In some embodiments, pattern training data 148 may be stored in pattern database 116. In some embodiments, pattern training data 148 may be retrieved from pattern database 116.

With continued reference to FIG. 1, at least a processor 104 may be configured to generate a system action advisory assignment 152. For the purposes of this disclosure, a “system action advisory assignment” is a task for a system user to improve a system behavioral pattern of the system user. In an embodiment, a system action advisory assignment 152 may improve a system behavioral pattern 140 of a system user. As a non-limiting example, a system action advisory assignment 152 may improve system educational behavior pattern, system vocational behavior pattern, system social media behavior pattern, system pecuniary behavior pattern, system personal behavior pattern, and the like. The examples of improving system behavioral pattern 140 are disclosed below In an embodiment, a system action advisory assignment 152 may improve financial literacy of a system user. As a non-limiting example, a system action advisory assignment 152 may improve low financial literacy of a system user. As another non-limiting example, a system action advisory assignment 152 may improve high financial literacy of a system user. In some embodiments, a system action advisory assignment 152 may include a plurality of system action advisory assignment 152s with a different level. As a non-limiting example, a level of a system action advisory assignment 152 may include easy, moderate, hard, and the like. As another non-limiting example, a level of a system action advisory assignment 152 may include 1, 2, 3, 4, 5, and the like, wherein 1 may indicate the easiest system action advisory assignment 152. In an embodiment, a system user may manually input a system action advisory assignment 152 into at least a processor 104. In another embodiment, a third party may manually input a system action advisory assignment 152 into at least a processor. In some embodiments, a system action advisory assignment 152 may be stored in pattern database 116. In some embodiments, a system action advisory assignment 152 may be retrieved from pattern database 116. Additionally without limitation, more disclosure related to generating a system action advisory assignment 152 may be found in U.S. patent application Ser. No. 18/131,647, filed on Apr. 6, 2023, and titled “APPARATUS AND METHODS FOR DETECTING A PATTERN TO GENERATE AN ASSIGNMENT,” having attorney docket number 1325-026USU1, the entirety of which is incorporated by reference herein.

With continued reference to FIG. 1, in some embodiments, a system action advisory assignment 152 may include a system gameplay element. For the purposes of this disclosure, a “system gameplay element” is an element suggested to a system user to improve a system behavioral pattern of the system user by completing it. In an embodiment, a system gameplay element may include playing an online game. As a non-limiting example, an online game may include a game that teaches a system user how to spend money, how to invest, how to save money, how to manage work-life balance, how to not procrastinate, how to find a new job, how to balance spending ratio of income, and the like In another embodiment, a system gameplay element may include a real-life activity. As a non-limiting example, a system gameplay element may include a real-life activity a system user needs to do a house chore, do homework, take a course, exercise, study, work a certain period of time, and the like.

With continued reference to FIG. 1, in some embodiments, a system action advisory assignment 152 may include a system action plan. For the purposes of this disclosure, a “system action plan” is a piece information to modify and/or improve a system pecuniary behavior of a system user. In an embodiment, a system action plan may include a list of companies. For the purposes of this disclosure, a “list of companies” is a list of companies that a system user can invest in. In another embodiment, a system action plan may include a list of products. As used in this disclosure, a “list of products” is a list of products that a system user can invest in. In some embodiments, a system action plan may include an information session related to an investment. As a non-limiting example, an information session may include a text of definition of different types of an investment, wherein the different types of an investment may include stocks, bonds, mutual funds, retirement plans, cryptocurrencies, index funds, and the like. As another non-limiting example, an information session may include a video lecture explaining a difference between value investing and quality investing. As another non-limiting example, an information session may include an animation showing the importance of investing money.

With continued reference to FIG. 1, in some embodiments, a system action advisory assignment 152 may further include another system action advisory assignment 152. In an embodiment, a system action plan may include a system gameplay element. As a non-limiting example, a list of companies of a system action plan may include a system gameplay element that teaches a how to invest in the companies in the investment list. As another non-limiting example, a list of products of a system action plan may include a system gameplay element that teaches how to invest in stocks.

With continued reference to FIG. 1, in some embodiments, a system action advisory assignment 152 may include a system behavior modification. For the purposes of this disclosure, a “system behavior modification” is an alternative behavior suggestion for a system user. As a non-limiting example, a system behavior modification may include a system behavior modification of system educational behavior pattern, system vocational behavior pattern, system social media behavior pattern, system pecuniary behavior pattern, system personal behavior pattern, and the like. As a non-limiting example, a system behavior modification of system educational behavior pattern may include studying 2 more hours to increase a score for an exam, taking 3 more courses to achieve a career goal, increase a frequency of taking an online course in a week from 1 time to 2 times, and the like. As a non-limiting example, a system behavior modification of system vocational behavior pattern may include working less hours a day at an office, working more hours from home, increase a frequency of searching for a new job in a week from 2 times to 3 times, and the like. As a non-limiting example, a system behavior modification of system social medial behavior pattern may include browsing less hour related to clothes contents, spending less time browsing social media, posting another type of contents in social media, increase a frequency of posting in social media, and the like. As a non-limiting example, a system behavior modification of system personal behavior pattern may include scheduling an alarm for paying a rent every month, scheduling an alarm to wash dishes every night, and the like. As a non-limiting example, a system behavior modification of system pecuniary behavior pattern may include spending less on purchasing in-game currency, investing more money on stocks, putting more money on a saving account for 10 months, stop borrowing money from a parent, start paying off credit card debts, and the like.

With continued reference to FIG. 1, at least a processor 104 may generate a system action advisory assignment 152 using an assignment machine-learning model 156. For the purposes of this disclosure, an “assignment machine-learning model” is a machine-learning model that is used to generate an action advisory assignment. An assignment machine-learning model 156 disclosed herein may be consistent with a machine-learning module disclosed with respect to FIG. 3. In some embodiments, an assignment machine-learning model 156 may be trained with assignment training data 160 correlating system behavioral pattern 140 to a system action advisory assignment 152. As a non-limiting example, assignment training data 160 may correlate posting pattern of system social media pattern to system behavioral modification. As another non-limiting example, assignment training data 160 may correlate system pecuniary pattern to system behavioral modification and system action advisory plan. In some embodiments, outputs of an assignment machine-learning model 156 may be used to train the assignment machine-learning model 156. In some embodiments, assignment training data 160 may be received from pattern database 116, external computing devices, and/or previous iterations of processing. In some embodiments, assignment training data 160 may be stored in pattern database 116. In some embodiments, assignment training data 160 may be retrieved from pattern database 116.

With continued reference to FIG. 1, at least a processor 104 is configured to receive external user data 168. For the purposes of this disclosure, “external user data” is data related to an external user. For the purposes of this disclosure, an “external user” is a user that does not have an account on apparatus 100. In some embodiments, the external user 176 may not have an account in apparatus 100. In some embodiments, external user data 168 may be stored in a pattern database 116. In some embodiments, external user data 168 may be retrieved from a pattern database 116. The pattern database 116 disclosed herein is further described in detail below. Additionally without limitation, external user data 168 disclosed herein may be consistent with user data found in U.S. patent application Ser. No. 18/131,647, filed on Apr. 6, 2023, and titled “APPARATUS AND METHODS FOR DETECTING A PATTERN TO GENERATE AN ASSIGNMENT,” having attorney docket number 1325-026USU1, the entirety of which is incorporated by reference herein.

With continued reference to FIG. 1, in an embodiment, external user data 168 may include external personal data. For the purposes of this disclosure, “external personal data” is data related to an external user's personal information. As a non-limiting example, external personal data may include name, gender, social security number, personal schedules, hobbies, personality type, dependents, family, profession, a life goal, a career goal, and the like. In some embodiments, external personal data may be stored in pattern database 116. In some embodiments, external personal data may be retrieved from pattern database 116. In another embodiment, external user data 168 may include external user financial data. For the purposes of this disclosure, “external user financial data” is data related to an external user's finance. As a non-limiting example, external user financial data may include cash reserves, assets, stocks, bonds, mutual funds, exchange-traded funds (ETF), equity, debts, real estates, incomes, financial goals, business plan, retirement accounts, liabilities, and the like. In some embodiments, external user financial data may be stored in pattern database 116. In some embodiments, external user financial data may be retrieved from pattern database 116.

With continued reference to FIG. 1, in some embodiments, external user data 168 includes external behavioral data 172 of an external user 176. For the purposes of this disclosure, “external behavioral data” is data relating to an external user's habits or tendencies. As a non-limiting example, external behavioral data 172 may include external educational behavior, external vocational behavior, external pecuniary behavior, external social media behavior, and the like. For the purposes of this disclosure, an “external educational behavior” is a behavior of an external user that is related to an education. As a non-limiting example, an external educational behavior may include amount of time invested in for studying a mid-term exam, amount of money used to buy a textbook, amount of time invested in to create a mid-term exam, a list of courses an external user 176 takes for a summer semester, and the like. In some embodiments, an external educational behavior may include a formal and informal education and training an external user 176 has received. In an embodiment, an education may include a degree. As a non-limiting example, a degree may include Bachelors, Masters, High School Diploma, Ph.D., Middle School Diploma, Elementary school diploma, Kindergarten diploma, and the like. In another embodiment, an education may include an occupational certification. As a non-limiting example, Pipefitting certification, commercial driver's license, welding certification, and the like. In some embodiments, an education may include job training. In some embodiments, external behavioral data 172 of external educational behavior may be obtained from on internet. As a non-limiting example, documentation for external educational behavior may include an official transcript, graduation diploma, enrollment letter, a certificate for online course completion, and the like. In some embodiments, external behavioral data 172 of external educational behavior may be obtained by tracking an external user online activity on internet. As a non-limiting example, a name of course an external user 176 had taken may be tracked. In some embodiments, external educational behavior may be stored in pattern database 116. In some embodiments, external educational behavior may be retrieved from pattern database 116.

With continued reference to FIG. 1, for the purposes of this disclosure, a “current vocational behavior” is a behavior of an external user that is related to a vocation. As a non-limiting example, external vocational behavior may include amount of time invested in searching for a new job, amount of time invested to learn a new skill for a job, time spent to learn a new skill, working hour, a career goal, and the like. In some embodiments, external behavioral data 172 of current vocational behavior may be obtained from documentation on internet. As a non-limiting example, documentation for external vocational behavior may include a W-2, employment acceptance letter, offer letter, and the like. In some embodiments, external behavioral data 172 of external vocational behavior may be obtained by tracking an external user online activity on internet. As a non-limiting example, amount of time an external user 176 spent on a job searching website may be tracked. In some embodiments, external vocational behavior may be stored in pattern database 116. In some embodiments, external vocational behavior may be retrieved from pattern database 116.

With continued reference to FIG. 1, for the purposes of this disclosure, an “external social media behavior” is a behavior of an external user that is related to social media. As a non-limiting example, external social media behavior may include posting, browsing time, browsed contents, commenting, and the like. As used in this disclosure, a “social media” is a content sharing platform. As a non-limiting example, social media may include Google, Instagram, Facebook, LinkedIn, and the like. In some embodiments, external behavioral data 172 of external social media behavior may by tracking an external user online activity on internet. As a non-limiting example, amount of time an external user 176 spent on social media app may be tracked. As another non-limiting example, a type of contents an external user 176 browsed on social media app may be tracked. As another non-limiting example, words an external user 176 searched on social media app may be tracked. In some embodiments, external social media behavior may be stored in pattern database 116. In some embodiments, external social media may be retrieved from pattern database 116.

With continued reference to FIG. 1, for the purposes of this disclosure, an “external pecuniary behavior” is a behavior of an external user related to money. In an embodiment, external pecuniary behavior may include real-life external pecuniary behavior. As a non-limiting example, external pecuniary behavior may include earning money, spending money, saving money, donating money, bank activity, investing, and the like. As another non-limiting example, a current pecuniary behavior may include increase rate of salary, a time when an external user 176 get a bonus, a time when an external user 176 get an allowance, amount of money an external user 176 get as an allowance, amount of money an external user 176 withdraw from a saving account at once, amount of money an external user 176 put money in a saving account, what an external user 176 buy in a restaurant, shopping at a mall, donating money to a charity once a month, groceries shopping, online shopping, products bought online, amount of money spent for online shopping, websites used for online shopping, stock investing, buying a house, borrowing money from a parent, borrowing money from a bank, paying back to a parent, paying back to a credit union, paying credit card, spending with a credit card, spending with a debit card, public transportation fee, and the like. In another embodiment, external pecuniary behavior may include an online external pecuniary behavior. As a non-limiting example, online external pecuniary behavior may include purchasing a game item with in-game currency, exchanging money and in-game currency, wherein in-game currency is any type of money used within a game, and the like. In some embodiments, external behavioral data 172 of external pecuniary behavior may be obtained from documentation on internet. As a non-limiting example, documentation for external pecuniary behavior may include a paystub, checking account statement, saving account statement, investment statement, profit and loss statement, and the like. In some embodiments, external behavioral data 172 of external pecuniary behavior may be obtained by tracking an external pecuniary behavior on internet. As a non-limiting example, a frequency an external user 176 doing online shopping may be tracked. In some embodiments, an external pecuniary behavior may be tracked using a wearable device. As a non-limiting example, a wearable device may track time an external user 176 spends in a groceries store. In some embodiments, external pecuniary behavior may be stored in pattern database 116. In some embodiments, external pecuniary may be retrieved from pattern database 116.

With continued reference to FIG. 1 in an embodiment, external user data 168 may be inputted by way of a device. As a non-limiting example, a device may include a phone, tablet, a laptop, a smart watch, and the like. In some embodiments, external user data 168 may include wearable device data that tracks a user's activity. As used in the current disclosure, a “wearable device” is a computing device that is designed to be worn on a user's body or clothing. The wearable device may detect wearable device data. In embodiments, a wearable device may include a smart watch, smart ring, fitness tracking device, and the like. As used in the current disclosure, “wearable device data” is data collected by a wearable device pertaining to a user. Wearable device data may include data and associated analysis corresponding to, for instance and without limitation, accelerometer data, pedometer data, gyroscope data, electrocardiography (ECG) data, electrooculography (EOG) data, bioimpedance data, blood pressure and heart rate monitoring, oxygenation data, biosensors, fitness trackers, force monitors, motion sensors, video and voice capture data, social media platform data, and the like. In some embodiments, external user data 168 may include tracking internet activity. As a non-limiting example, internet activity may include content browsing with a phone, content browsing with a laptop, online-shopping using a phone, internet surfing using a phone, and the like. In some embodiments, external user data 168 may be collected through a survey, as described below. In some embodiments, external user data 168 may include audiovisual data. Audiovisual data may include text, voice memos, videos, photos, or the like. In an embodiment, external user data 168 may include document data. As used in this disclosure, “document data” is data obtained from a document. As a non-limiting example, external user data 168 may include a budgeting spreadsheet of an external user 176's finances, bank statement, tax return, and the like. In some embodiments, at least a processor 104 may receive external user data 168 from optical character recognition (OCR). The OCR disclosed herein is further described below.

With continued reference to FIG. 1, in some embodiments, at least a processor 104 may include optical character recognition (OCR). Optical character recognition may include automatic conversion of images of written, such as without limitation typed, handwritten or printed text, into machine-encoded text. In some cases, recognition of at least a keyword from an image component may include one or more processes, including without limitation optical character recognition (OCR), optical word recognition, intelligent character recognition, intelligent word recognition, and the like. In some cases, OCR may recognize written text, one glyph or character at a time. In some cases, optical word recognition may recognize written text, one word at a time, for example, for languages that use a space as a word divider. In some cases, intelligent character recognition (ICR) may recognize written text one glyph or character at a time, for instance by employing machine learning processes. In some cases, intelligent word recognition (IWR) may recognize written text, one word at a time, for instance by employing machine learning processes.

With continued reference to FIG. 1, in some cases, OCR may be an “offline” process, which analyses a static document or image frame. In some cases, handwriting movement analysis can be used as input to a handwriting recognition. For example, instead of merely using shapes of glyphs and words, this technique may capture motions, such as the order in which segments are drawn, the direction, and the pattern of putting the pen down and lifting it. This additional information can make handwriting recognition more accurate. In some cases, this technology may be referred to as “online” character recognition, dynamic character recognition, real-time character recognition, and intelligent character recognition.

With continued reference to FIG. 1, in some cases, OCR processes may employ pre-processing of image component. Pre-processing process may include without limitation de-skew, de-speckle, binarization, line removal, layout analysis or “zoning,” line and word detection, script recognition, character isolation or “segmentation,” and normalization. In some cases, a de-skew process may include applying a transform, such as without limitation homography or affine transform, to image component to align text. In some cases, a de-speckle process may include removing positive and negative spots and/or smoothing edges. In some cases, a binarization process may include converting an image from color or greyscale to black-and-white, such as without limitation a binary image. Binarization may be performed as a simple way of separating text or any other desired image component from a background of image component. In some cases, binarization may be required for example if an employed OCR algorithm only works on binary images. In some cases. A line removal process may include removal of non-glyph or non-character imagery, such as without limitation boxes and lines. In some cases, a layout analysis or “zoning” process may identify columns, paragraphs, captions, and the like as distinct blocks. In some cases, a line and word detection process may establish a baseline for word and character shapes and separate words, if necessary. In some cases, a script recognition process may, for example in multilingual documents, identify script allowing an appropriate OCR algorithm to be selected. In some cases, a character isolation or “segmentation” process may separate signal characters, for example character-based OCR algorithms. In some cases, a normalization process may normalize aspect ratio and/or scale of image component.

With continued reference to FIG. 1, in some embodiments an OCR process will include an OCR algorithm. Exemplary OCR algorithms include matrix matching process and/or feature extraction processes. Matrix matching may involve comparing an image to a stored glyph on a pixel-by-pixel basis. In some case, matrix matching may also be known as “pattern matching,” “pattern recognition,” and/or “image correlation.” Matrix matching may rely on an input glyph being correctly isolated from the rest of the image component. Matrix matching may also rely on a stored glyph being in a similar font and at a same scale as input glyph. Matrix matching may work best with typewritten text.

With continued reference to FIG. 1, in some embodiments, an OCR process may include a feature extraction process. In some cases, feature extraction may decompose a glyph into features. Exemplary non-limiting features may include corners, edges, lines, closed loops, line direction, line intersections, and the like. In some cases, feature extraction may reduce dimensionality of representation and may make the recognition process computationally more efficient. In some cases, extracted feature can be compared with an abstract vector-like representation of a character, which might reduce to one or more glyph prototypes. General techniques of feature detection in computer vision are applicable to this type of OCR. In some embodiments, machine-learning process like nearest neighbor classifiers (e.g., k-nearest neighbors algorithm) can be used to compare image features with stored glyph features and choose a nearest match. OCR may employ any machine-learning process described in this disclosure, for example machine-learning processes described with reference to FIGS. 3-5. Exemplary non-limiting OCR software may include Cuneiform and Tesseract. Cuneiform is a multi-language, open-source optical character recognition system originally developed by Cognitive Technologies of Moscow, Russia. Tesseract is free OCR software originally developed by Hewlett-Packard of Palo Alto, California, United States.

With continued reference to FIG. 1, in some cases, OCR may employ a two-pass approach to character recognition. Second pass may include adaptive recognition and use letter shapes recognized with high confidence on a first pass to recognize better remaining letters on the second pass. In some cases, two-pass approach may be advantageous for unusual fonts or low-quality image components where visual verbal content may be distorted. Another exemplary OCR software tool may include OCRopus. OCRopus development is led by German Research Centre for Artificial Intelligence in Kaiserslautern, Germany. In some cases, OCR software may employ neural networks, for example neural networks as described in reference to FIGS. 3-5.

With continued reference to FIG. 1, in some cases, OCR may include post-processing. For example, OCR accuracy can be increased, in some cases, if output is constrained by a lexicon. A lexicon may include a list or set of words that are allowed to occur in a document. In some cases, a lexicon may include, for instance, all the words in the English language, or a more technical lexicon for a specific field. In some cases, an output stream may be a plain text stream or file of characters. In some cases, an OCR process may preserve an original layout of visual verbal content. In some cases, near-neighbor analysis can make use of co-occurrence frequencies to correct errors, by noting that certain words are often seen together. For example, “Washington, D.C.” is generally far more common in English than “Washington DOC.” In some cases, an OCR process may make us of a priori knowledge of grammar for a language being recognized. For example, grammar rules may be used to help determine if a word is likely to be a verb or a noun. Distance conceptualization may be employed for recognition and classification. For example, a Levenshtein distance algorithm may be used in OCR post-processing to further optimize results. Additional disclosure on OCR may be found in U.S. patent application Ser. No. 17/872,950, filed on Jul. 25, 2022, and titled “APPARATUS AND METHODS FOR ANALYZING DEFICIENCIES,” having attorney docket number 1325-008USU1, the entirety of which is incorporated by reference herein.

With continued reference to FIG. 1, external user data 168 may include survey data. The survey data may include responses to a survey given to a user. In another embodiment, the survey data may include responses to a survey given to a third party. A third party may include employers, parents, teachers, or the like that may be able to provide feedback on a user's behavior. The survey data may be presented on a graphical user interface. The survey data may include multiple choice questions and/or free text questions. The survey data may include questions wherein a user can rate themselves. The survey may include questions regarding a user's pecuniary literacy, pecuniary history, occupation, educational history, overall health history, behavioral patterns, and the like.

With continued reference to FIG. 1, in some embodiments, external user data 168 may be derived from a web crawler. A “web crawler,” as used herein, is a program that systematically browses the internet for the purpose of Web indexing. The web crawler may be seeded with platform URLs, wherein the crawler may then visit the next related URL, retrieve the content, index the content, and/or measures the relevance of the content to the topic of interest. In some embodiments, at least a processor 104 may generate a web crawler to scrape external user data 168 from crypto sites, investing sites, social media sites, blogs, and/or forums. The web crawler may be seeded and/or trained with a reputable website, such as robinhood.com, to begin the search. A web crawler may be generated by at least a processor 104. In some embodiments, the web crawler may be trained with information received through a user interface. The user interface disclosed herein is further described below. In some embodiments, the web crawler may be configured to generate a web query. A web query may include search criteria received from a user. For example, a user may submit a plurality of websites for the web crawler to search external user data 168 from and correlate to external user data 168 such as without limitation external personal data, external user financial data, external behavioral data 172, and the like. As a non-limiting example, the external behavioral data 172 may include external educational behavior, external social media behavior, external pecuniary behavior, external vocational behavior, and the like. Additionally, the web crawler function may be configured to search for and/or detect one or more data patterns. A “data pattern” as used in this disclosure is any repeating forms of information. A data pattern may include repeating external personal data, external user financial data, external behavioral data 172, and the like. As a non-limiting example, the external behavioral data 172 may include external educational behavior, external social media behavior, external pecuniary behavior, external vocational behavior, and the like. In some embodiments, the web crawler may be configured to determine the relevancy of a data pattern. Relevancy may be determined by a relevancy score. A relevancy score may be automatically generated by at least a processor 104, received from a machine learning model, and/or received from the user. In some embodiments, a relevancy score may include a range of numerical values that may correspond to a relevancy strength of data received from a web crawler function. As a non-limiting example, a web crawler function may search the Internet for external user data 168 related to an external user 176. The web crawler may return external user data 168, such as, as non-limiting examples, external personal data, external user financial data, external behavioral data 172, and the like. As a non-limiting example, the external behavioral data 172 may include external educational behavior, external social media behavior, external pecuniary behavior, external vocational behavior, and the like.

With continued reference to FIG. 1, for the purposes of this disclosure, a “user interface” is a means by which a user and a computer system interact; for example through the use of input devices and software. A user interface may include a graphical user interface (GUI), command line interface (CLI), menu-driven user interface, touch user interface, voice user interface (VUI), form-based user interface, any combination thereof and the like. In some embodiments, user interface may operate on and/or be communicatively connected to a decentralized platform, metaverse, and/or a decentralized exchange platform associated with the user. For example, a user may interact with user interface in virtual reality. In some embodiments, a user may interact with the use interface using a computing device distinct from and communicatively connected to at least a processor 104. For example, a smart phone, smart, tablet, or laptop operated by the user. A user interface may include one or more graphical locator and/or cursor facilities allowing a user to interact with graphical models and/or combinations thereof, for instance using a touchscreen, touchpad, mouse, keyboard, and/or other manual data entry device. In an embodiment, user interface may include a graphical user interface. A “graphical user interface,” as used herein, is a graphical form of user interface that allows users to interact with electronic devices. In some embodiments, GUI may include icons, menus, other visual indicators, or representations (graphics), audio indicators such as primary notation, and display information and related user controls. A menu may contain a list of choices and may allow users to select one from them. A menu bar may be displayed horizontally across the screen such as pull-down menu. When any option is clicked in this menu, then the pull-down menu may appear. A menu may include a context menu that appears only when the user performs a specific action. An example of this is pressing the right mouse button. When this is done, a menu may appear under the cursor. Files, programs, web pages and the like may be represented using a small picture in a graphical user interface. For example, links to decentralized platforms as described in this disclosure may be incorporated using icons. Using an icon may be a fast way to open documents, run programs, and the like because clicking on them yields instant access. Persons skilled in the art, upon reviewing the entirety of this disclosure, will be aware of various ways in which a graphical user interface and/or elements thereof may be implemented and/or used as described in this disclosure. Additional disclosure on graphical user interface may be found in U.S. patent application Ser. No. 17/872,099, filed on Jul. 25, 2022, and titled “A GRAPHICAL USER INTERFACE FOR ANIMATING USER DATA,” having attorney docket number 1325-001USU1, the entirety of which is incorporated by reference herein.

With continued reference to FIG. 1, in some embodiments, information contained in user interface may be directly influenced using graphical control elements such as widgets. A “widget,” as used herein, is a user control element that allows a user to control and change the appearance of elements in the user interface. In this context a widget may refer to a generic GUI element such as a check box, button, or scroll bar to an instance of that element, or to a customized collection of such elements used for a specific function or application such as without limitation a dialog box for users to customize their computer screen appearances. User interface controls may include software components that a user interacts with through direct manipulation to read or edit information displayed through user interface. Widgets may be used to display lists of similar items, navigate the system using links, tabs, and manipulate data using check boxes, radio boxes, and the like.

With continued reference to FIG. 1, a user interface include may a carousel widget. A “carousel widget,” as used herein, is a graphical widget used to display visual cards in a way that is quick for users to browse. As a non-limiting example, the carousel widget may slide, fade, collapse, zoom, minimize, enlarge, open, move in and out of view, and the like in response to mouse or touch interaction. In some embodiments, a user interface may include a cover flow widget. A “cover flow widget,” as used herein in, is an animated, three-dimensional widget for visually flipping through media. As a non-limiting example, the cover flow widget may flip through using an on-screen scrollbar, mouse wheel, gestures, or by selecting a file from a list, which flips through the pages to bring the associated image into view. In some embodiments, a widget may include a collapsible panel, which, as used herein, is a panel that can compactly store content which is hidden or revealed by clicking the tab of the widget. A widget may include a window, which, as used herein, is a graphical control element consisting of a visual area containing some of the graphical user interface elements of the program it belongs to. A widget may include an accordion, which, as used herein, is a vertically stacked list of items, such as labels or thumbnails where each item can be “expanded” to reveal the associated content. A widget may include a dialog box, which, as used herein, is a small window that communicates information to the user and prompts a response. A widget may include a palette window, which, as used herein, is a graphical control element which floats on top of all regular windows and offers ready access tools, commands, or information for the current application. A widget may include a frame, which, as used herein, is a type of box within which a collection of graphical control elements can be grouped as a way to show relationships visually. Additionally a widget may include a canvas, which, as used herein, is a generic drawing element for representing graphical information.

With continued reference to FIG. 1, a user interface may include a media player. A “media player,” as used herein, is a software program playing multimedia computer files like audio and video files. The media player may include control icons such as play, pause, fast forward, back forward, and stop icons. The media player may include a progress bar. A “progress bar,” as used herein, is s a graphical control element used to visualize the progression of an extended computer operation, such as without limitation a download, file transfer, or installation. Sometimes, the graphic may be accompanied by a textual representation of the progress in a percent format. The concept can also be regarded to include “playback bars” in media players that keep track of the current location in the duration of a media file. Additionally, the media player may include a seek bar. A “seek bar,” as used in this disclosure, is an extension of the progress bar that adds a draggable thumb. The user can touch the thumb and drag left or right to set the current progress level or use the arrow keys. The media player may include a timer with the current and total playback time, playlists, a “repeat” mode, and a “shuffle” or “random” mode for curiosity and to facilitate searching long timelines of files. Options to change the video's scaling and aspect ratio may include filling the viewport through either stretching or cropping, and “100% view” where each pixel of the video covers exactly one pixel on the screen. Zooming into the field of view during playback may be implemented through a slider on any screen or with pinch zoom on touch screens and moving the field of view may be implemented through scrolling by dragging inside the view port or by moving a rectangle inside a miniature view of the entire field of view that denotes the magnified area. Media player software may have the ability to adjust appearance and acoustics during playback using effects such as mirroring, rotating, cropping, cloning, adjusting colors, deinterlacing, and equalizing and visualizing audio.

With continued reference to FIG. 1, additionally or alternatively, at least a processor 104 may receive external user data 168 from augmented reality. Additional disclosure on augmented reality may be found in U.S. patent application Ser. No. 17/872,630, filed on Jul. 25, 2022, and titled “AN APPARATUS FOR GENERATING AN AUGMENTED REALITY,” having attorney docket number 1325-002USU1, the entirety of which is incorporated by reference herein.

With continued reference to FIG. 1, at least a processor 104 is configured to classify external user data 168 into one or more external behavioral groups 180. As used in this disclosure, an “external behavioral group” is a set of associative external user data. As a non-limiting example, one or more external behavioral groups 180 may include external educational group, external vocational group, external social media group, external pecuniary group, external personal group, and the like. For the purposes of this disclosure, an “external educational group” is a set of associative external user data of an external educational behavior. As a non-limiting example, external educational group may include a school attendance group, course attendance group, course group, diploma group, study time group, subjects' group, and the like. For the purposes of this disclosure, an “external vocational group” is a set of associative external user data of an external vocational behavior. For the purposes of this disclosure, an “external social media group” is a set of associative external user data of an external social media behavior. For the purposes of this disclosure, an “external pecuniary group” is a set of associative external user data of an external pecuniary behavior. In some embodiments, an external pecuniary group may include external spending group, external saving group, external investing group, external donating group, and the like. As a non-limiting example, external spending group may include external purchased product group, external groceries shopping group, external online shopping group, external paying debts group, external paying credit card payments group, external paying a rent group, credit card group, current debit card group, external online game group, and the like. As another non-limiting example, external investing group may include external stocks group, external bonds group, external trusts group, external real-estates group, and the like. As another non-limiting example, external saving group may include external withdraw group, external saving group, and the like. As another non-limiting example, external donating group may include external purchased products for donation group, external donating companies' group, and the like. For the purposes of this disclosure, an “external personal group” is a set of associative external user data of an external personal behavior. As a non-limiting example, external personal group may include external missing due dates group, external personality test results group, external family group, external life goal group, external schedule group, and the like.

With continued reference to FIG. 1, in some embodiments, at least a processor 104 may be configured to classify external user data 168 into one or more external behavioral groups 180 using a group classifier 132. In some embodiments, a group classifier 132 may be trained with a group training data 136 correlating system data 110 and/or system user data 112 to system behavioral groups 128. The correlation of the group training data 136 may allow the group classifier 132 to classify external user data 168 to one or more external behavioral groups 180. As a non-limiting example, group training data 136 may correlate a system pecuniary behavior to system pecuniary groups. Then, as the non-limiting example, the correlation of the group training data 136 may allow a group classifier 132 to classify an external pecuniary behavior to an external pecuniary group. As another non-limiting example, group training data 136 may correlate system social media behavior to a system social media group. Then, as another non-limiting example, the correlation of the group training data 136 may allow a group classifier 132 to classify an external social media behavior to an external social media group. The correlation of group training data 136 may allow group classifier 132 to classify external user data 168 to one or more external behavioral groups. In some embodiments, group training data 136 may be stored in pattern database 116. In some embodiments, group training data 136 may be retrieved from pattern database 116.

With continued reference to FIG. 1, at least a processor 104 is configured to determine an external behavioral pattern 184 of an external user 176 as a function of external behavioral groups. For the purposes of this disclosure, an “external behavioral pattern” is data relating to an external user's reoccurring behaviors. In some embodiments, external behavioral pattern 184 may include a range of time. As a non-limiting example, a range of time may include an hour, a day, 3 days, a week, 2 weeks, 5 weeks, a month, 6 months, a year, 10 years, and the like. In an embodiment, external behavioral pattern 184 may include external educational behavior pattern, external vocational behavior pattern, external pecuniary behavior pattern, external social media behavior pattern, external personal behavior pattern, external sharing behavior pattern, and the like. In some embodiments, an external behavioral pattern 184 may be stored in pattern database 116. In some embodiments, an external behavioral pattern 184 may be retrieved from pattern database 116.

With continued reference to FIG. 1, for the purposes of this disclosure, an “external educational behavior pattern” is an external behavioral pattern of an external user related to education. As a non-limiting example, an external educational behavior pattern may include a list of scores an external user 176 get in a certain subject at school in a semester, a frequency of an external user 176 taking a certain subject at school in a semester, a number of times an external user 176 missing a deadline for an assignment in a year, a frequency of taking an online course in a month, a number of times an external user 176 achieved a career goal within 3 years, and the like. For the purposes of this disclosure, a “subject” is an area of knowledge that an external user can study. As a non-limiting example, a subject may include math, science, literature, music, and the like.

With continued reference to FIG. 1, for the purposes of this disclosure, an “external vocational behavior pattern” is an external behavioral pattern of an external user related to user's vocation. As a non-limiting example, an external vocational behavior pattern may include most frequently searched job titles, amount of time an external user 176 spends to search for a new job for a week, amount of time an external user 176 worked in the office for 5 days, amount of time an external user 176 worked from home for a month, a frequency an external user 176 worked from home for 3 months, and the like.

With continued reference to FIG. 1, for the purposes of this disclosure, an “external social media behavior pattern” is an external behavioral pattern of an external user related to social media. As a non-limiting example, an external social media behavior pattern may include browsing pattern, posting pattern, commenting pattern, and the like. As another non-limiting example, an external social media behavior pattern may include a frequency an external user 176 opens social media in a day, a type of contents an external user 176 sees in social media, types of contents an external user 176 created on social media, amount of time an external user spends in social media, and the like. For the purposes of this disclosure, an “external personal behavior pattern” is a behavioral pattern related to an external user's personality. As a non-limiting example, an external personal behavior pattern may include a frequency an external user 176 procrastinates paying a rent fee for 10 years, a frequency an external user 176 has done house chores for 1 week, and the like.

With continued reference to FIG. 1, for the purposes of this disclosure, “external pecuniary behavior pattern” is an external behavioral pattern of an external user related to money. As a non-limiting example, external pecuniary behavior pattern may include spending habit, saving habit, investing habit, and the like. As another non-limiting example, external pecuniary behavior pattern may how many times an external user 176 do online shopping in a month, a frequency of getting an allowance, average money an external user 176 spend on online games each month for 6 months, a frequency of an external user 176 withdrawing money from a saving account, amount of money an external user 176 put into saving account in regular base, amount of money an external user 176 spend on investment each month for a year, a frequency of an external user 176 and the like.

With continued reference to FIG. 1, at least a processor 104 may determine external behavioral pattern 184 using pattern machine-learning model 144. In some embodiments, pattern machine-learning model 144 may be trained with pattern training data 148 correlating system data 110 and/or one or more system behavioral groups 128 to system behavioral pattern 140. Using these correlations, pattern machine-learning model 144 may determine external behavioral pattern 184 from external behavioral group 180. In some embodiments, pattern machine-learning model 144 may be trained with pattern training data 148 that correlates system behavioral groups 128 to system behavioral patterns 140. As a non-limiting example, pattern training data 148 may correlate system pecuniary group to a system pecuniary behavior pattern. Then, as the non-limiting example, the correlation of the pattern training data 148 may allow a pattern machine-learning model 144 to determine an external pecuniary behavior pattern from an external pecuniary group. As another non-limiting example, pattern training data 148 may correlate system social media group to system social media behavior pattern. Then, as another non-limiting example, the correlation of the pattern training data 148 may allow a pattern machine-learning model 144 to determine an external social media behavior pattern from an external social media group. In some embodiments, pattern training data 148 may be received from pattern database 116, external computing devices, and/or previous iterations of processing. In some embodiments, pattern training data 148 may be stored in pattern database 116. In some embodiments, pattern training data 148 may be retrieved from pattern database 116.

With continued reference to FIG. 1, at least a processor 104 is configured to generate an external action advisory assignment 188 as a function of system data 110. For the purposes of this disclosure, a “external action advisory assignment 188” is a task for an external user to improve an external behavioral pattern of the external user. In an embodiment, an external action advisory assignment 188 may improve an external behavioral pattern 184 of an external user 176. As a non-limiting example, an external action advisory assignment 188 may improve external educational behavior pattern, external vocational behavior pattern, external social media behavior pattern, external pecuniary behavior pattern, external personal behavior pattern, and the like. The examples of improving external behavioral pattern 184 are disclosed below. In an embodiment, an external action advisory assignment 188 may improve financial literacy of an external user 116. For the purposes of this disclosure, “financial literacy” is the ability of a current user to understand and effectively use various financial skills. As a non-limiting example, a financial skill may include personal financial management, budgeting, investing, and the like. In some embodiments, an external action advisory assignment 188 may include a plurality of external action advisory assignments 188 with a different level. As a non-limiting example, a level of an external action advisory assignment 188 may include easy, moderate, hard, and the like. As another non-limiting example, a level of an external action advisory assignment 188 may include 1, 2, 3, 4, 5, and the like, wherein 1 may indicate the easiest external action advisory assignment 188. In another embodiment, a third party may manually input an external action advisory assignment 188 into at least a processor. In some embodiments, an external action advisory assignment 188 may be stored in pattern database 116. In some embodiments, an external action advisory assignment 188 may be retrieved from pattern database 116.

With continued reference to FIG. 1, in some embodiments, an external action advisory assignment 188 may include a current gameplay element. For the purposes of this disclosure, an “external gameplay element” is an element suggested to an external user to improve an external behavioral pattern of the external user by completing it. In an embodiment, an external gameplay element may include playing an online game. As a non-limiting example, an online game may include a game that teaches an external user 176 how to spend money, how to invest, how to save money, how to manage work-life balance, how to not procrastinate, how to find a new job, how to balance spending ratio of income, and the like. In another embodiment, an external gameplay element may include a real-life activity. As a non-limiting example, an external gameplay element may include a real-life activity an external user 176 needs to do a house chore, do homework, take a course, exercise, study, work a certain period of time, and the like.

With continued reference to FIG. 1, in some embodiments, an external action advisory assignment 188 may include an external action plan. For the purposes of this disclosure, an “external action plan” is a piece information to modify and/or improve an external pecuniary behavior of an external user. In an embodiment, a current action plan may include a list of companies. In another embodiment, an external action plan may include a list of products. In some embodiments, an external action plan may include an information session related to an investment. As a non-limiting example, an information session may include a text of definition of different types of an investment, wherein the different types of an investment may include stocks, bonds, mutual funds, retirement plans, cryptocurrencies, index funds, and the like. As another non-limiting example, an information session may include a video lecture explaining a difference between value investing and quality investing. As another non-limiting example, an information session may include an animation showing the importance of investing money.

With continued reference to FIG. 1, in some embodiments, an external action advisory assignment 188 may further include another external action advisory assignment 188. In an embodiment, an external action plan may include an external gameplay element. As a non-limiting example, a list of companies of an external action plan may include an external gameplay element that teaches a how to invest in the companies in the investment list. As another non-limiting example, a list of products of an external action plan may include an external gameplay element that teaches how to invest in stocks.

With continued reference to FIG. 1, in some embodiments, an external action advisory assignment 188 may include an external behavior modification. For the purposes of this disclosure, an “external behavior modification” is an alternative behavior suggestion for an external user. As a non-limiting example, an external behavior modification may include an external behavior modification of external educational behavior pattern, external vocational behavior pattern, external social media behavior pattern, external pecuniary behavior pattern, external personal behavior pattern, and the like. As a non-limiting example, an external behavior modification of external educational behavior pattern may include studying 2 more hours to increase a score for an exam, taking 3 more courses to achieve a career goal, increase a frequency of taking an online course in a week from 1 time to 2 times, and the like. As a non-limiting example, an external behavior modification of external vocational behavior pattern may include working less hours a day at an office, working more hours from home, increase a frequency of searching for a new job in a week from 2 times to 3 times, and the like. As a non-limiting example, an external behavior modification of external social medial behavior pattern may include browsing less hour related to clothes contents, spending less time browsing social media, posting another type of contents in social media, increase a frequency of posting in social media, and the like. As a non-limiting example, an external behavior modification of external personal behavior pattern may include scheduling an alarm for paying a rent every month, scheduling an alarm to wash dishes every night, and the like. As a non-limiting example, an external behavior modification of external pecuniary behavior pattern may include spending less on purchasing in-game currency, investing more money on stocks, putting more money on a saving account for 10 months, stop borrowing money from a parent, start paying off credit card debts, and the like. In some embodiments, an external action advisory assignment 188 may include a system action advisory assignment 152. As a non-limiting example, an external action advisory assignment 188 may include system gameplay element, system action plan, system behavior modification, and the like.

With continued reference to FIG. 1, at least a processor 104 may generate an external action advisory assignment 188 using an assignment machine-learning model 156. In some embodiments, an assignment machine-learning model 156 may be trained with assignment training data 160 that correlates system data 110 and/or system behavioral patterns 140 to system action advisory assignments 152. Assignment machine-learning model 156 may, after being trained, be used to generate an external action advisory assignment 188. As a non-limiting example, an assignment machine-learning model 156 may be trained with assignment training data 160 that correlates system pecuniary pattern to a system action advisory assignment 152 of system behavior modification. Then, as the non-limiting example, the correlation of the assignment training data 160 may allow an assignment machine learning model 156 to generate an external action advisory assignment 188 of external behavior modification for an external pecuniary pattern. As another non-limiting example, an assignment machine-learning model 156 may be trained assignment training data 160 that correlates system social media pattern to a system action advisory assignment 152 of system behavior modification and system gameplay element. Then, as another non-limiting example, the correlation of the assignment training data 160 may allow an assignment machine learning model 156 to generate an external action advisory assignment 188 of external behavior modification and external gameplay element for an external social media pattern. In some embodiments, assignment training data 160 may be received from pattern database 116, external computing devices, and/or previous iterations of processing. In some embodiments, assignment training data 160 may be stored in pattern database 116. In some embodiments, assignment training data 160 may be retrieved from pattern database 116. Additionally without limitation, more disclosure of generating an external action advisory assignment 188 as a function of an external behavioral pattern 184 may be found in U.S. patent application Ser. No. 18/131,647, filed on Apr. 6, 2023, and titled “APPARATUS AND METHODS FOR DETECTING A PATTERN TO GENERATE AN ASSIGNMENT,” having attorney docket number 1325-026USU1, the entirety of which is incorporated by reference herein.

With continued reference to FIG. 1, at least a processor 104 may be configured to generate a report. For the purposes of this disclosure, a “report” is a collection of information that is formed to display or communicate the collection of information. In some embodiments, a report may include a form of a text, a graph, a trend line, a chart, audio, animation, an image, a video, and the like. As a non-limiting example, a report may include an educational report, a vocational report, a social media report, a pecuniary report, a personal report, a match report, and the like. For the purposes of this disclosure, an “educational report” is a report that graphically displays a current educational behavior pattern. As a non-limiting example, an educational report may include a text that includes a list of scores an external user 176 got for exams for a year. For the purposes of this disclosure, a “vocational report” is a report that graphically displays a vocational behavior pattern. As a non-limiting example, a vocational report may include a table of a list of house chores an external user 176 did for a week. For the purposes of this disclosure, a “social media report” is a report that graphically displays a current social media behavior pattern. As a non-limiting example, a social media report may include a video of contents an external user 176 browsed in social media for a year. For the purposes of this disclosure, a “personal report” is a report that graphically displays a current personal behavior pattern. As a non-limiting example, a report may include a graph of number of times an external user 176 achieved life goals of the external user 176. For the purposes of this disclosure, a “pecuniary report” is a report that graphically displays a pecuniary behavior pattern. As a limiting example, a pecuniary report may include a graph of average money used for online shopping each month for 6 months. As another non-limiting example, a pecuniary report may include a chart of income earned from investing for 1 year. As another non-limiting example, a pecuniary report may include an animation that shows spending ratio of income of an external user 176. In some embodiments, a report may be stored in pattern database 116. In some embodiments, a report may be retrieved from pattern database 116.

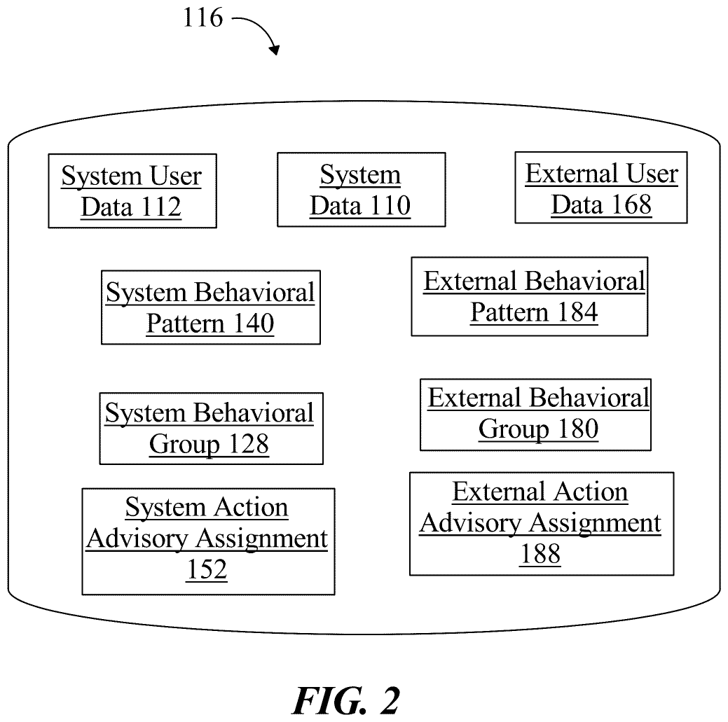

Referring now to FIG. 2, an exemplary embodiment of a pattern database 116 is shown. Apparatus 100 may include a pattern database 116. As used in this disclosure, a “pattern database” is a database of a system for detecting a pattern of data to generate an assignment. As a non-limiting example, a pattern database 116 may include system data 110, system user data 112, system behavioral pattern 128, system action advisory assignment 152, system behavioral group 128, system behavioral pattern group 152, external user data 168, external behavioral pattern 184, external action advisory assignment 188, external behavioral group 180, external behavioral pattern group 188, and the like. Database may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure. In some embodiments, an external user 176 may manually input data into a pattern database 116. In some embodiments, a third party may manually input data into a pattern database 116. At least a processor 104 may be communicatively connected to a pattern database 116. For example, in some cases, pattern database 116 may be local to at least a processor 104. Alternatively or additionally, in some cases, pattern database 116 may be remote to at least a processor 104 and communicative with at least a processor 104 by way of one or more networks. Network may include, but not limited to, a cloud network, a mesh network, or the like. By way of example, a “cloud-based” system, as that term is used herein, can refer to a system which includes software and/or data which is stored, managed, and/or processed on a network of remote servers hosted in the “cloud,” e.g., via the Internet, rather than on local severs or personal computers. A “mesh network,” as used in this disclosure, is a local network topology in which the infrastructure a processor connects directly, dynamically, and non-hierarchically to as many other computing devices as possible. A “network topology” as used in this disclosure is an arrangement of elements of a communication network.

Referring now to FIG. 3, an exemplary embodiment of a machine-learning module 300 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 304 to generate an algorithm that will be performed by apparatus 100/module to produce outputs 308 given data provided as inputs 312; this is in contrast to a non-machine learning software program where the commands to be executed are determined in advance by a user and written in a programming language.

With continued reference to FIG. 3, for instance, and without limitation, training data 304 may include a plurality of data entries, each entry representing a set of data elements that were recorded, received, and/or generated together; data elements may be correlated by shared existence in a given data entry, by proximity in a given data entry, or the like. Multiple data entries in training data 304 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 304 according to various correlations; correlations may indicate causative and/or predictive links between categories of data elements, which may be modeled as relationships such as mathematical relationships by machine-learning processes as described in further detail below. Training data 304 may be formatted and/or organized by categories of data elements, for instance by associating data elements with one or more descriptors corresponding to categories of data elements. As a non-limiting example, training data 304 may include data entered in standardized forms by persons or processes, such that entry of a given data element in a given field in a form may be mapped to one or more descriptors of categories. Elements in training data 304 may be linked to descriptors of categories by tags, tokens, or other data elements; for instance, and without limitation, training data 304 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and with continued reference to FIG. 3, training data 304 may include one or more elements that are not categorized; that is, training data 304 may not be formatted or contain descriptors for some elements of data. Machine-learning algorithms and/or other processes may sort training data 304 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 304 to be made applicable for two or more distinct machine-learning algorithms as described in further detail below. Training data 304 used by machine-learning module 300 may correlate any input data as described in this disclosure to any output data as described in this disclosure.

With continued reference to FIG. 3, training data may be filtered, sorted, and/or selected using one or more supervised and/or unsupervised machine-learning processes and/or models as described in further detail below; such models may include without limitation a training data classifier 318. Training data classifier 318 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 300 may generate a classifier using a classification algorithm, defined as a process whereby apparatus 100 and/or any module and/or component operating thereon derives a classifier from training data 304. Classification may be performed using, without limitation, linear classifiers such as without limitation logistic regression and/or naïve Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

With continued reference to FIG. 3, machine-learning module 300 may be configured to perform a lazy-learning process 320 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 304. Heuristic may include selecting some number of highest-ranking associations and/or training data 304 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 3, machine-learning processes as described in this disclosure may be used to generate machine-learning models 324. A “machine-learning model,” as used in this disclosure, is a mathematical and/or algorithmic representation of a relationship between inputs and outputs, as generated using any machine-learning process including without limitation any process as described above and stored in memory 118; an input is submitted to a machine-learning model 324 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 324 may be generated by creating an artificial neural network, such as a convolutional neural network comprising an input layer of nodes, one or more intermediate layers, and an output layer of nodes. Connections between nodes may be created via the process of “training” the network, in which elements from a training data 304 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

With continued reference to FIG. 3, machine-learning algorithms may include at least a supervised machine-learning process 328. At least a supervised machine-learning process 328, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include inputs and outputs, as described above, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 304. Persons skilled in the art, upon reviewing the entirety of this disclosure, will be aware of various possible variations of at least a supervised machine-learning process 328 that may be used to determine relation between inputs and outputs. Supervised machine-learning processes may include classification algorithms as defined above.

With continued reference to FIG. 3, machine learning processes may include at least an unsupervised machine-learning processes 332. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

With continued reference to FIG. 3, machine-learning module 300 may be designed and configured to create a machine-learning model 324 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the LASSO model is the Frobenius norm amounting to the square root of the sum of squares of all terms. Linear regression models may include the elastic net model, a multi-task elastic net model, a least angle regression model, a LARS LASSO model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

With continued reference to FIG. 3, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

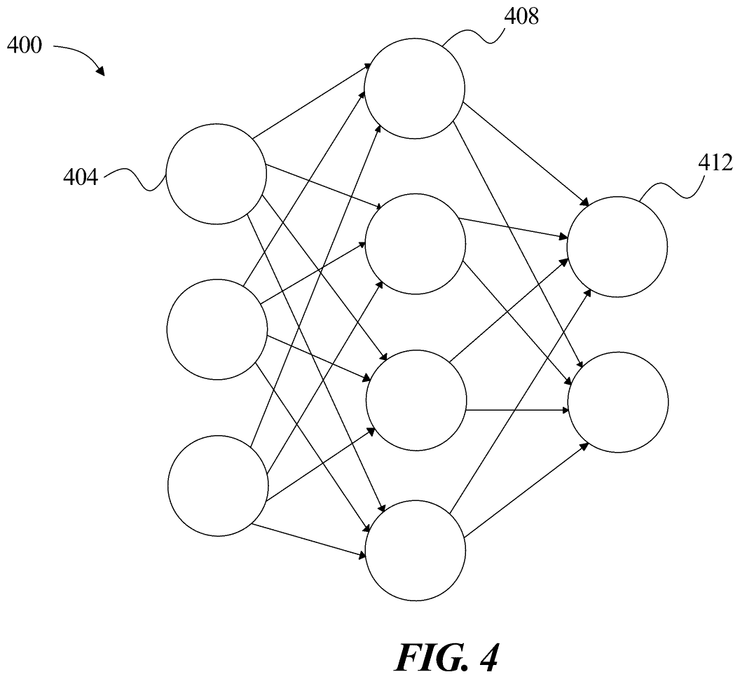

Referring now to FIG. 4, an exemplary embodiment of neural network 400 is illustrated. A neural network 400 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 404, one or more intermediate layers 408, and an output layer of nodes 412. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

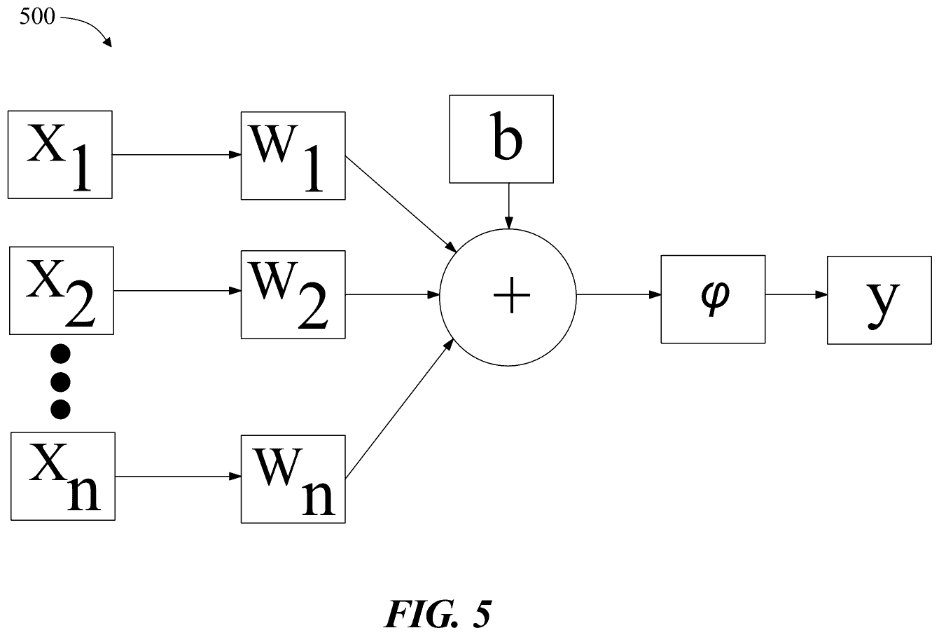

Referring now to FIG. 5, an exemplary embodiment of a node of a neural network is illustrated. A node may include, without limitation, a plurality of inputs xi that may receive numerical values from inputs to a neural network containing the node and/or from other nodes. Node may perform a weighted sum of inputs using weights wi that are multiplied by respective inputs xi. Additionally or alternatively, a bias b may be added to the weighted sum of the inputs such that an offset is added to each unit in the neural network layer that is independent of the input to the layer. The weighted sum may then be input into a function q, which may generate one or more outputs y. Weight wi applied to an input xi may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight.

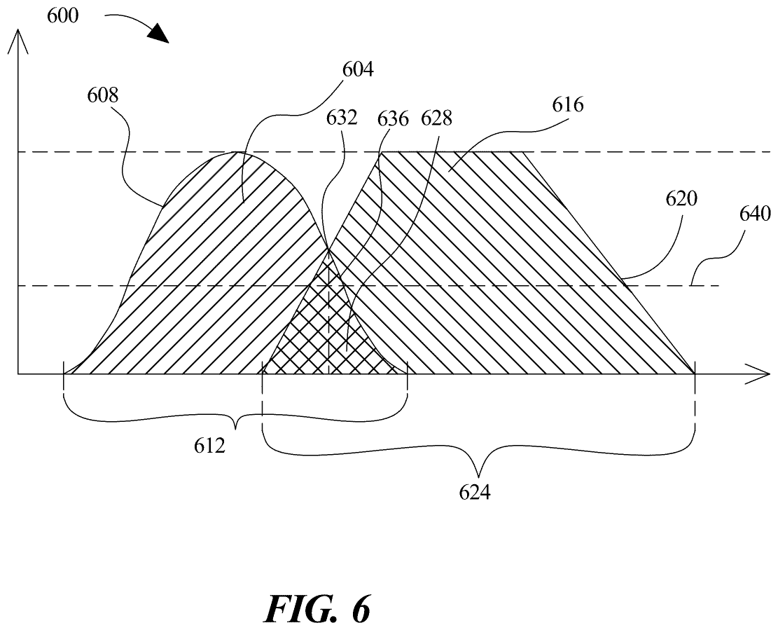

Referring now to FIG. 6, an exemplary embodiment of fuzzy set comparison 600 is illustrated. A first fuzzy set 604 may be represented, without limitation, according to a first membership function 608 representing a probability that an input falling on a first range of values 612 is a member of the first fuzzy set 604, where the first membership function 608 has values on a range of probabilities such as without limitation the interval [0,1], and an area beneath the first membership function 608 may represent a set of values within first fuzzy set 604. Although first range of values 612 is illustrated for clarity in this exemplary depiction as a range on a single number line or axis, first range of values 612 may be defined on two or more dimensions, representing, for instance, a Cartesian product between a plurality of ranges, curves, axes, spaces, dimensions, or the like. First membership function 608 may include any suitable function mapping first range 612 to a probability interval, including without limitation a triangular function defined by two linear elements such as line segments or planes that intersect at or below the top of the probability interval. As a non-limiting example, triangular membership function may be defined as:

$$y ( x , a , b , c ) = \{ \begin{matrix}0 , for x > c and x < a \\ \frac{x - a}{b - a} , for a \leq x < b \\ \frac{c - x}{c - b} , if b < x \leq c\end{matrix}$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

With continued reference to FIG. 6, first fuzzy set 604 may represent any value or combination of values as described above, including output from one or more machine-learning models and/or a predetermined class. A second fuzzy set 616, which may represent any value which may be represented by first fuzzy set 604, may be defined by a second membership function 620 on a second range 624; second range 624 may be identical and/or overlap with first range 612 and/or may be combined with first range via Cartesian product or the like to generate a mapping permitting evaluation overlap of first fuzzy set 604 and second fuzzy set 616. Where first fuzzy set 604 and second fuzzy set 616 have a region 628 that overlaps, first membership function 608 and second membership function 620 may intersect at a point 672 representing a probability, as defined on probability interval, of a match between first fuzzy set 604 and second fuzzy set 616. Alternatively or additionally, a single value of first and/or second fuzzy set may be located at a locus 676 on first range 612 and/or second range 624, where a probability of membership may be taken by evaluation of first membership function 608 and/or second membership function 620 at that range point. A probability at 628 and/or 672 may be compared to a threshold 640 to determine whether a positive match is indicated. Threshold 640 may, in a non-limiting example, represent a degree of match between first fuzzy set 604 and second fuzzy set 616, and/or single values therein with each other or with either set, which is sufficient for purposes of the matching process; for instance, threshold may indicate a sufficient degree of overlap between an output from one or more machine-learning models and/or a predetermined class for combination to occur as described above. Alternatively or additionally, each threshold may be tuned by a machine-learning and/or statistical process, for instance and without limitation as described in further detail below.

With continued reference to FIG. 6, in an embodiment, a degree of match between fuzzy sets may be used to classify any data described as classified above. Where multiple fuzzy matches are performed, degrees of match for each respective fuzzy set may be computed and aggregated through, for instance, addition, averaging, or the like, to determine an overall degree of match.

With continued reference to FIG. 6, in an embodiment, an element of data may be compared to multiple fuzzy sets. For instance, the element of data may be represented by a fuzzy set that is compared to each of the multiple fuzzy sets representing, e.g., values of a linguistic variable; and a degree of overlap exceeding a threshold between the datum-linked fuzzy set and any of the multiple fuzzy sets may cause computing device to classify the datum as belonging to each such categorization. Machine-learning methods as described throughout may, in a non-limiting example, generate coefficients used in fuzzy set equations as described above, such as without limitation x, c, and o of a Gaussian set as described above, as outputs of machine-learning methods.

With continued reference to FIG. 6, a computing device may use a logic comparison program, such as, but not limited to, a fuzzy logic model to determine an output and/or response. An output and/or response may include, but is not limited to low, medium, advanced, superior, good, bad, and the like; each such output and/or response may be represented as a value for a linguistic variable representing output and/or response or in other words a fuzzy set as described above that corresponds to a degree of completion as calculated using any statistical, machine-learning, or other method that may occur to a person skilled in the art upon reviewing the entirety of this disclosure.

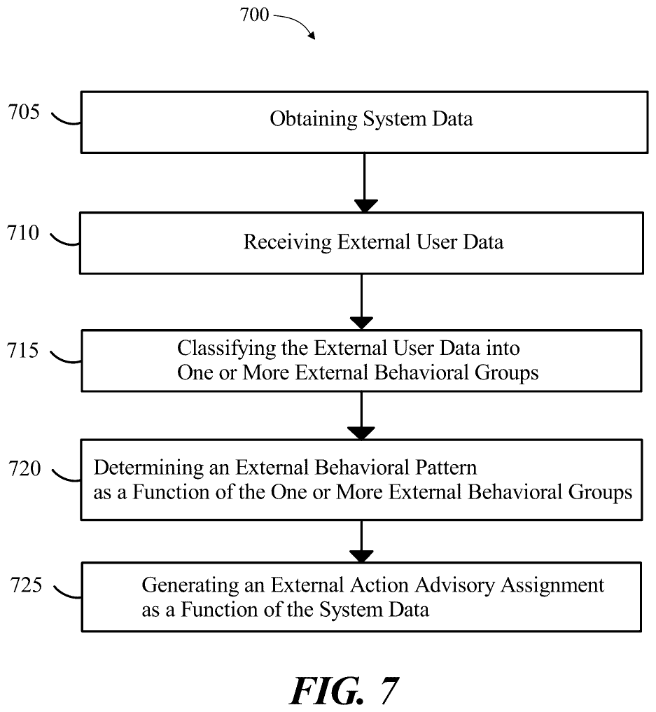

Referring now to FIG. 7, a flow diagram of a method 700 of processing data for external users is illustrated. Method 700 includes a step 705 of obtaining, using at least a processor, system data, wherein the system data comprises system user data, one or more system behavioral groups, a system behavioral pattern and a system action advisory assignment. Method 700 includes a step 710 of receiving, using the at least a processor, external user data. In some embodiments, the external user data may include external behavioral data. In some embodiments, the external behavioral data may include current social media behavior. In some embodiments, the external user data may include wearable device data. Method 700 includes a step 715 of classifying, using the at least a processor, the external user data into one or more external behavioral groups. Method 700 includes a step 720 of determining, using the at least a processor, an external behavioral pattern of the external user as a function of the system data. In some embodiments, determining the external behavioral pattern of the external user includes receiving, using a pattern classifier, pattern training data, wherein the pattern training data may include the system data, training the pattern classifier using the pattern training data, and determining, using the pattern classifier, the external behavioral pattern as a function of the system data. Method 700 includes a step 725 of generating, using the at least a processor, external action advisory assignment for an external user as a function of the system data. In some embodiments, generating the external action advisory assignment includes receiving, using an assignment machine-learning model, assignment training data, wherein the assignment training data includes the external behavioral pattern, training the assignment machine-learning model using the assignment training data, and generating, using the assignment machine-learning model, the external action advisory assignment as a function of the assignment training data. In some embodiments, the external action advisory assignment may include behavioral modification. In some embodiments, the external action advisory assignment may include an action plan, wherein the action plan comprises a list of companies. In some embodiments, method 700 may further include generating, using the at least a processor, a report, wherein the report may include a pecuniary report. These may be implemented as disclosed with reference to FIGS. 1-6.

It is to be noted that any one or more of the aspects and embodiments described herein may be conveniently implemented using one or more machines (e.g., one or more computing devices that are utilized as a user computing device for an electronic document, one or more server devices, such as a document server, and the like.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, and the like.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

With continued reference to FIG. 6, an inference engine may be implemented according to input and/or output membership functions and/or linguistic variables. For instance, a first linguistic variable may represent a first measurable value pertaining to an element being input to the inferencing system while a second membership function may indicate a degree and/or category of one or more other attributes and/or values that may be associated with a system user. Continuing the example, an output linguistic variable may represent, without limitation, a value representing a strength and/or deficiency. An inference engine may combine rules the degree to which a given input function membership matches a given rule may be determined by a triangular norm or “T-norm” of the rule or output membership function with the input membership function, such as min (a, b), product of a and b, drastic product of a and b, Hamacher product of a and b, or the like, satisfying the rules of commutativity (T(a, b)=T(b, a)), monotonicity: (T(a, b)≤T(c, d) if a≤c and b≤d), (associativity: T(a, T(b, c))=T(T(a, b), c)), and the requirement that the number 1 acts as an identity element. Combinations of rules (“and” or “or” combination of rule membership determinations) may be performed using any T-conorm, as represented by an inverted T symbol or “⊥” such as max (a, b), probabilistic sum of a and b (a+b−a*b), bounded sum, and/or drastic T-conorm; any T-conorm may be used that satisfies the properties of commutativity: ⊥(a, b)=⊥(b, a), monotonicity: ⊥(a, b)≤⊥(c, d) if a≤c and b≤d, associativity: ⊥(a, ⊥(b, c))=⊥(⊥(a, b), c), and identity element of 0. Alternatively or additionally T-conorm may be approximated by sum, as in a “product-sum” inference engine in which T-norm is product and T-conorm is sum. A final output score or other fuzzy inference output may be determined from an output membership function as described above using any suitable defuzzification process, including without limitation Mean of Max defuzzification, Centroid of Area/Center of Gravity defuzzification, Center Average defuzzification, Bisector of Area defuzzification, or the like. Alternatively or additionally, output rules may be replaced with functions according to the Takagi-Sugeno-King (TSK) fuzzy model.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, and the like.), a web appliance, a network router, a network switch, a network bridge, any machine capable of executing a sequence of instructions that specify an action to be taken by that machine, and any combinations thereof. In one example, a computing device may include and/or be included in a kiosk.

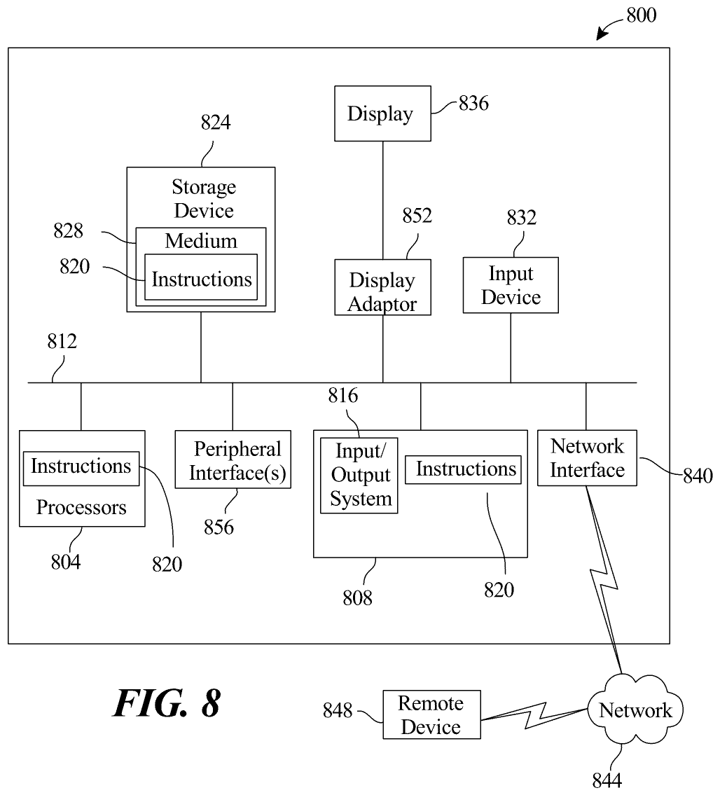

Referring now to FIG. 8, it shows a diagrammatic representation of one embodiment of a computing device in the exemplary form of a computer system 800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 800 includes a processor 804 and a memory 808 that communicate with each other, and with other components, via a bus 812. Bus 812 may include any of several types of bus structures including, but not limited to, a memory bus, a memory controller, a peripheral bus, a local bus, and any combinations thereof, using any of a variety of bus architectures.

Processor 804 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 804 may be organized according to Von Neumann and/or Harvard architecture as a non-limiting example. Processor 804 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 808 may include various components (e.g., machine-readable media) including, but not limited to, a random-access memory component, a read only component, and any combinations thereof. In one example, a basic input/output system 816 (BIOS), including basic routines that help to transfer information between elements within computer system 800, such as during start-up, may be stored in memory 808. Memory 808 may also include (e.g., stored on one or more machine-readable media) instructions (e.g., software) 820 embodying any one or more of the aspects and/or methodologies of the present disclosure. In another example, memory 808 may further include any number of program modules including, but not limited to, an operating system, one or more application programs, other program modules, program data, and any combinations thereof.

Computer system 800 may also include a storage device 824. Examples of a storage device (e.g., storage device 824) include, but are not limited to, a hard disk drive, a magnetic disk drive, an optical disc drive in combination with an optical medium, a solid-state memory device, and any combinations thereof. Storage device 824 may be connected to bus 812 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 824 (or one or more components thereof) may be removably interfaced with computer system 800 (e.g., via an external port connector (not shown)). Particularly, storage device 824 and an associated machine-readable medium 828 may provide nonvolatile and/or volatile storage of machine-readable instructions, data structures, program modules, and/or other data for computer system 800. In one example, software 820 may reside, completely or partially, within machine-readable medium 828. In another example, software 820 may reside, completely or partially, within processor 804.

Computer system 800 may also include an input device 832. In one example, a user of computer system 800 may enter commands and/or other information into computer system 800 via input device 832. Examples of an input device 832 include, but are not limited to, an alpha-numeric input device (e.g., a keyboard), a pointing device, a joystick, a gamepad, an audio input device (e.g., a microphone, a voice response system, and the like.), a cursor control device (e.g., a mouse), a touchpad, an optical scanner, a video capture device (e.g., a still camera, a video camera), a touchscreen, and any combinations thereof. Input device 832 may be interfaced to bus 812 via any of a variety of interfaces (not shown) including, but not limited to, a serial interface, a parallel interface, a game port, a USB interface, a FIREWIRE interface, a direct interface to bus 812, and any combinations thereof. Input device 832 may include a touch screen interface that may be a part of or separate from display 836, discussed further below. Input device 832 may be utilized as a user selection device for selecting one or more graphical representations in a graphical interface as described above.

A user may also input commands and/or other information to computer system 800 via storage device 824 (e.g., a removable disk drive, a flash drive, and the like.) and/or network interface device 840. A network interface device, such as network interface device 840, may be utilized for connecting computer system 800 to one or more of a variety of networks, such as network 844, and one or more remote devices 848 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 844, may employ a wired and/or a wireless mode of communication. In general, any network topology may be used. Information (e.g., data, software 820, and the like.) may be communicated to and/or from computer system 800 via network interface device 840.

Computer system 800 may further include a video display adapter 852 for communicating a displayable image to a display device, such as display device 836. Examples of a display device include, but are not limited to, a liquid crystal display (LCD), a cathode ray tube (CRT), a plasma display, a light emitting diode (LED) display, and any combinations thereof. Display adapter 852 and display device 836 may be utilized in combination with processor 804 to provide graphical representations of aspects of the present disclosure. In addition to a display device, computer system 800 may include one or more other peripheral output devices including, but not limited to, an audio speaker, a printer, and any combinations thereof. Such peripheral output devices may be connected to bus 812 via a peripheral interface 856. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, apparatuses, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

What is claimed is:

1. An apparatus for processing data for external users, wherein the apparatus comprises:
at least a processor; and
a memory communicatively connected to the at least a processor, the memory containing instructions configuring the at least a processor to:
obtain system data, wherein the system data comprises system user data, one or more system behavioral groups, a system behavioral pattern and a system action advisory assignment;
receive external user data;
classify the external user data into one or more external behavioral groups;
determine an external behavioral pattern of the external user data in the one or more external behavioral groups as a function of the system data; and
generate an external action advisory assignment for an external user as a function of the system data.

2. The apparatus of claim 1, wherein the external user data comprises external behavioral data.

3. The apparatus of claim 2, wherein the external behavioral data further comprises external social media behavior.

4. The apparatus of claim 1, wherein the external user data comprises wearable device data.

5. The apparatus of claim 1, wherein determining the external behavioral pattern of the external user comprises:
receiving, using a pattern classifier, pattern training data, wherein the pattern training data comprises the system data;
training the pattern classifier using the pattern training data; and
determining, using the pattern classifier, the external behavioral pattern as a function of the system data.

6. The apparatus of claim 1, wherein generating the external action advisory assignment comprises:
receiving, using an assignment machine-learning model, assignment training data, wherein the assignment training data comprises the external behavioral pattern;
training the assignment machine-learning model using the assignment training data; and
generating, using the assignment machine-learning model, the external action advisory assignment as a function of the assignment training data.

7. The apparatus of claim 1, wherein the external action advisory assignment comprises behavioral modification.

8. The apparatus of claim 1, wherein the external assignment comprises the system action advisory assignment.

9. The apparatus of claim 1, wherein the external action advisory assignment comprises an action plan, wherein the action plan comprises a list of companies.

10. The apparatus of claim 1, wherein the at least a processor is further configured to generate a report, wherein the report comprises a pecuniary report.

11. A method for processing data for external users, wherein the method comprises:
obtaining, using at least a processor, system data, wherein the system data comprises system user data, one or more system behavioral groups, a system behavioral pattern and a system action advisory assignment;
receiving, using the at least a processor, external user data;
classifying, using the at least a processor, the external user data into one or more external behavioral groups;
determining, using the at least a processor, an external behavioral pattern of the external user as a function of the system data; and
generating, using the at least a processor, an external action advisory assignment for an external user as a function of the system data.

12. The method of claim 11, wherein the external user data comprises external behavioral data.

13. The method of claim 12, wherein the external behavioral data further comprises external social media behavior.

14. The method of claim 11, wherein the external user data comprises wearable device data.

15. The method of claim 11, wherein determining the external behavioral pattern of the external user comprises:
receiving, using a pattern classifier, pattern training data, wherein the pattern training data comprises the system data;
training the pattern classifier using the pattern training data; and
determining, using the pattern classifier, the external behavioral pattern as a function of the system data.

16. The method of claim 11, wherein generating the external action advisory assignment comprises:
receiving, using an assignment machine-learning model, assignment training data, wherein the assignment training data comprises the external behavioral pattern;
training the assignment machine-learning model using the assignment training data; and
generating, using the assignment machine-learning model, the external action advisory assignment as a function of the assignment training data.

17. The method of claim 11, wherein the external action advisory assignment comprises behavioral modification.

18. The method of claim 11, wherein the external assignment comprises the system action advisory assignment.

19. The method of claim 11, wherein the external action advisory assignment comprises an action plan, wherein the action plan comprises a list of companies.

20. The apparatus of claim 1, further comprising:
generating, using the at least a processor, a report, wherein the report comprises a pecuniary report.
